(19) United States
(12) Patent Application Publication
(10) Pub. No.: US 2026/0230182 A1
(43) Pub. Date: Aug. 6, 2026

(54) METHOD AND DEVICE FOR ADJUSTING MODULATION TIMING IN OPTICAL COMMUNICATION SYSTEM

(71) Applicant: NEC Corporation, Tokyo (JP)

(72) Inventor: Ken-ichiro YOSHINO, Tokyo (JP)

(73) Assignee: NEC Corporation, Tokyo (JP)

(21) Appl. No.: 19/152,013

(22) PCT Filed: Feb. 8, 2023
(86) PCT No.: PCT/JP2023/004154

§ 371 Date: Jul. 30, 2025

(51) Int. Cl. H04B 10/079; H04B 10/516

(52) U.S. Cl. CPC H04B 10/079; H04B 10/516

(57) ABSTRACT

[Problem] To provide a new modulation timing adjustment method and device that can optimize the modulation timing of a modulator in the optical communication system.

[Solution] A modulation timing adjustment device that adjusts modulation timing of a modulator 11 that modulates a train of light pulses P_{IN} with a predetermined period, is provided. The device includes: a variance calculator 14 that calculates a variance V of a detection signal DS of an output light pulse P_{OUT} of the modulator 11; and a controller 15 that, while shifting the modulation timing of the modulator 11, obtains the variance V of the detection signal DS at each modulation timing, and adjusts the modulation timing based on the variance V, wherein the controller 15 determines a modulation timing at which the variance V reaches a maximum as a criterion for determining an optimal modulation timing.

### TECHNICAL FIELD

The present invention relates to optical communication systems, and in particular to techniques of adjusting the modulation timing of light pulses.

### BACKGROUND ART

In a case where light pulses having a period of T are modulated by an optical modulator, the optical modulator must be driven at the timing of the light pulse passing through the optical modulator. If the modulation timing is off, the desired amount of modulation cannot be obtained, resulting in an increase in the error rate of the demodulated data. Therefore, several modulation timing adjustment methods have been proposed to drive the optical modulator in accordance with the timing of the passage of each light pulse.

For example, Patent Literature 1 (PTL 1) describes a method of monitoring the error rate of received data at the receiving side and adjusting the modulation timing at the transmitting side so that the error rate is minimized. Also, Patent Literature 2 (PTL 2) describes a method of combining light modulated by multiple optical modulators at the transmitter and adjusting the modulation timing based on the intensity of the combined light.

### CITATION LIST

### Patent Literature

[PTL 1] Japanese Patent Publication No. 2007-020011

[PTL 2] International Publication No. 2018/061303

### SUMMARY OF INVENTION

### Technical Problem

However, the error rate of received data may be degraded by various causes. For example, changes in environmental temperature may cause fluctuations in delays in optical transmission lines and electrical circuits, resulting in an increase in the error rate due to an error in the timing of light pulses passing through the modulator. The error rate may also increase due to failure of stabilization control of an optical system. For example, in a Quantum Key Distribution (QKD) system, an interferometer is configured between the transmitter and receiver, so that a malfunction of the stabilization control can be a major cause of the error rate increase. Therefore, by simply monitoring the error rate, it is difficult to determine which is the cause of the error rate increase, the modulation timing problem or the optical system problem.

The method of monitoring the intensity of the combined light allows adjustment of the modulation timing at the transmitter, but does not allow adjustment of the modulation timing at the receiver. For example, in some QKD systems, a modulator may be provided not only in the transmitter but also in the receiver. In this system, it is necessary to also adjust the modulation timing in the modulator of the receiver.

An object of the present invention is to provide a new modulation timing adjustment method and device and a receiver that can optimize the modulation timing of a modulator in the optical communication system.

### Solution to Problem

According to a first aspect of the present disclosure, a modulation timing adjustment device that adjusts modulation timing of a modulator that modulates light pulses with a predetermined period, the device includes: a variance calculator that calculates a variance of a detection signal of an output light pulse of the modulator; and a controller that, while shifting the modulation timing of the modulator, obtains the variance of the detection signal at each modulation timing, and adjusts the modulation timing based on the variance, wherein the controller determines the modulation timing at which the variance reaches a maximum as a criterion for determining an optimal modulation timing.

According to a second aspect of the present disclosure, a modulation timing adjustment method for a data processor to adjust modulation timing of a modulator that modulates light pulses with a predetermined period, the method includes: calculating a variance of a detection signal obtained by detecting an output light pulse train of the modulator while shifting the modulation timing of the modulator; and optimizing the modulation timing using a modulation timing at which the variance reaches a maximum as a criterion timing.

According to a third aspect of the present disclosure, a program that functions a computer as a modulation timing adjustment device for adjusting modulation timing of a modulator that modulates light pulses with a predetermined period, the program implements on the computer functions of: calculating a variance of a detection signal obtained by detecting an output light pulse train of the modulator while shifting the modulation timing of the modulator; and optimizing the modulation timing using a modulation timing at which the variance reaches a maximum as a criterion timing.

According to a fourth aspect of the present disclosure, a receiver connected to a transmitter through an optical transmission path in an optical communication system, the receiver includes: a reception unit that receives an output light pulse train of a modulator of the transmitter to detect a detection signal from the output light pulse train, wherein the modulator modulates a light pulse train with a predetermined period to output the output light pulse train; a variance calculator that calculates a variance of the detection signal; and a controller that, while shifting the modulation timing of the modulator, obtains the variance of the detection signal at each modulation timing, and optimizes the modulation timing using a modulation timing at which the variance reaches a maximum as a criterion timing.

According to a fifth aspect of the present disclosure, a receiver connected to a transmitter through an optical transmission path in an optical communication system, the receiver includes: a reception unit that receives a first output light pulse train of a first modulator of the transmitter, wherein the first modulator modulates a light pulse train with a predetermined period to output the first output light pulse train; a second modulator that modulates the first output light pulse train received from the transmitter through the optical transmission path; a variance calculator that calculates a variance of a detection signal obtained by detecting the second output light pulse train of the second modulator; and a controller that adjusts modulation timing of the first modulator and the second modulator based on the variance, wherein the controller, while shifting the modulation timing of the first modulator in a state of halting modulation operation of the second modulator, obtains the variance of the detection signal at each modulation timing, and optimizes the modulation timing of the first modulator using a modulation timing at which the variance reaches a maximum as a criterion timing; and after having optimized the modulation timing of the first modulator, the controller, while shifting the modulation timing of the second modulator, obtains the variance of the detection signal at each modulation timing, and optimizes the modulation timing of the second modulator using a modulation timing at which the variance reaches a maximum as a criterion timing.

### Advantageous Effects of Inventon

As described above, according to the present invention, variance of detection signal can be used to enable optimization of the modulation timing, without using the error rate or the intensity of the combined light, and independently of the operational failure of the stabilization control of the optical system.

### BRIEF DESCRIPTION OF DRAWINGS

FIG. 1 is a block diagram illustrating the schematic configuration of a modulation adjustment apparatus according to an example embodiment of the present invention.

FIG. 2 is a diagram for explaining an example of quadrature modulation in the present example embodiment.

FIG. 3 is a schematic diagram for explaining a change in variance of detection signal due to a change in modulation timing of a quadrature modulator in the present example embodiment.

FIG. 4 is a graph illustrating an example of a change in variance for explaining a setting method of optimal modulation timing according to the present example embodiment.

FIG. 5 is a schematic diagram illustrating an example of modulation voltage for explaining a change in detection signal variance in the present example embodiment.

FIG. 6 is a schematic diagram illustrating an example of change in variance depending on the position of an light pulse string with respect to changing modulation voltages in the present example embodiment.

FIG. 7 is a schematic diagram illustrating an example of change in modulation voltage used for modulation timing adjustment according to the present example embodiment.

FIG. 8 is a flowchart illustrating a first example of the operation of a modulation timing adjustment apparatus according to the present example embodiment.

FIG. 9 is a flowchart illustrating a second example of the operation of a modulation timing adjustment apparatus according to the present example embodiment.

FIG. 10 is a block diagram illustrating a schematic configuration of a continuous-variable QKD system to which the modulation timing adjustment apparatus according to an example of the present invention is applied.

FIG. 11 is a flowchart illustrating an example of the operation of the modulation timing adjustment apparatus illustrated in FIG. 10.

FIG. 12 is a diagram illustrating an example of a transmission bit string and the mapping from the transmission bit string to IQ space of the basis in a transmitter (Alice) illustrated in FIG. 10.

FIG. 13 is a schematic diagram for explaining the basis reconciliation in a receiver (Bob) illustrated in FIG. 10.

### DESCRIPTION OF EXAMPLE EMBODIMENTS

### Outline of Example Embodiments

According to example embodiments of the present invention, the variance of the detection signal of a train of modulated output light pulses is calculated while shifting the modulation timing of a modulator. The modulation timing at which the variance becomes maximized is used as a criterion for determining the optimal modulation timing. Based on the variance of the detection signal, the modulation timing can be optimized without using the error rate or the intensity of combined light, and independently of operational failures of stabilization control of an optical system.

For example, two adjacent modulation timings at each of which the variance reaches its peak can be used as criterion timing. The optimal modulation timing can be set at the midpoint between the two adjacent modulation timings. Alternatively, one modulation timing at which the variance reaches its peak can be also used as criterion timing. The optimal modulation timing can be set to the point in time shifted by half a period from the one modulation timing. The example embodiments and examples of the present invention will be described in detail with reference to the drawings.

### 1. Example Embodiment

### 1.1) Configuration

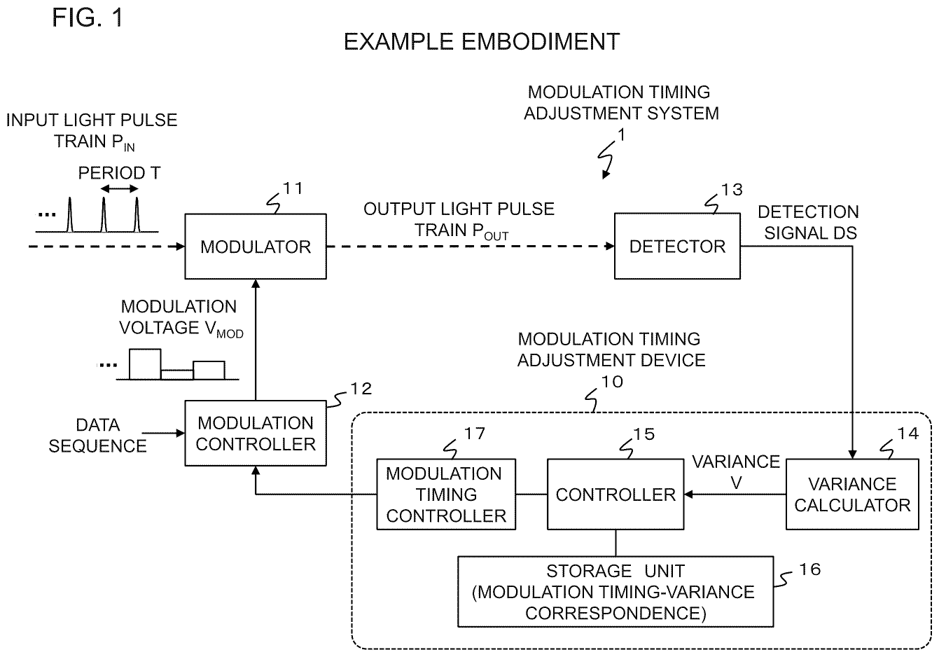

As illustrated in FIG. 1, the modulation timing adjustment system 1 includes a modulation timing adjustment device 10, a modulator 11, a modulation controller 12, and a detector 13. The modulator 11 modulates each light pulse of the input light pulse train P_{IN} with a predetermined period T and outputs an output light pulse train P_{OUT} of modulated light pulses.

The modulator 11 modulates each light pulse of the input light pulse train P_{IN} according to the modulation voltage V_{MOD} input from the modulation controller 12. The modulation controller 12 applies modulation voltages according to a data sequence to the modulator 11 in accordance with the passage timing of each input light pulse. The timing at which this modulation voltage is applied, modulation timing, is adjusted by the modulation timing adjustment device 10 as described below.

As the modulator 11, a phase modulator or a quadrature modulator (IQ modulator) may be employed. The quadrature modulator splits each input light pulse into two split light pulses and passes one through an in-phase (I-phase) path and the other through a quadrature phase (Q-phase) path. The quadrature modulator modulates the split light pulses according to transmission bits and then combines the resultant light pulses to generate a single output light pulse. The output light pulse is a multi-level phase/amplitude-modulated light pulse. Such a quadrature modulator may be composed of Mach-Zehnder (MZ) modulators in the I-phase and Q-phase paths, respectively. Quadrature modulation in this system is modulation that includes at least phase modulation such as QPSK (Quadrature Phase Shift Keying), 16QAM (Quadrature Amplitude Modulation), etc. Each symbol is represented as a different signal point on the IQ plane.

The output light pulse train P_{OUT} of the modulator 11 is detected by the detector 13 receiving it through an optical transmission path such as an optical fiber or free space. The detector 13 includes a photoelectric converter and a demodulator corresponding to the modulator 11. The detector 13 generates a detection signal DS of I and Q components from each light pulse of the output light pulse train P_{OUT} and outputs it to the modulation timing adjustment device 10.

The modulation timing adjustment device 10 includes a variance calculator 14, a controller 15, a storage unit 16, and a modulation timing controller 17. The variance calculator 14 calculates a numerical value indicating the signal spread on the IQ plane (hereinafter referred to as variance V) from the detection signal DS input from the detector 13. The variance V may be any numerical value indicating the degree of signal scatter, and the formula for calculating variance used in statistics may also be used.

The controller 15, when inputting the variance V from the variance calculator 14, maps it to modulation timing T_{M} at that time and stores it in the storage unit 16. The modulation timing is optimized by the modulation timing adjustment control as described below. The controller 15 controls the modulation timing controller 17 to obtain the variance V at each modulation timing while shifting the modulation timing T_{M}. More specifically, the controller 15 outputs an instruction to the modulation timing controller 17 to shift the modulation timing T_{M} by a predetermined step Δt. The modulation controller 12 outputs a modulation voltage V_{MOD} according to the data sequence to the modulator 11 at each modulation timing controlled by the modulation timing controller 17.

The controller 15 stores the variance V calculated from the detection signal DS at each modulation timing in the storage unit 16 by associating it with the modulation timing T_{M}. The controller 15 detects the modulation timing indicative of the maximum variance from the correspondence data of the modulation timing T_{M} and variance V stored in the storage unit 16. The detected modulation timing is used as a reference (criterion) for determining the optimum modulation timing.

### 1.2) Modulation Timing Adjustment

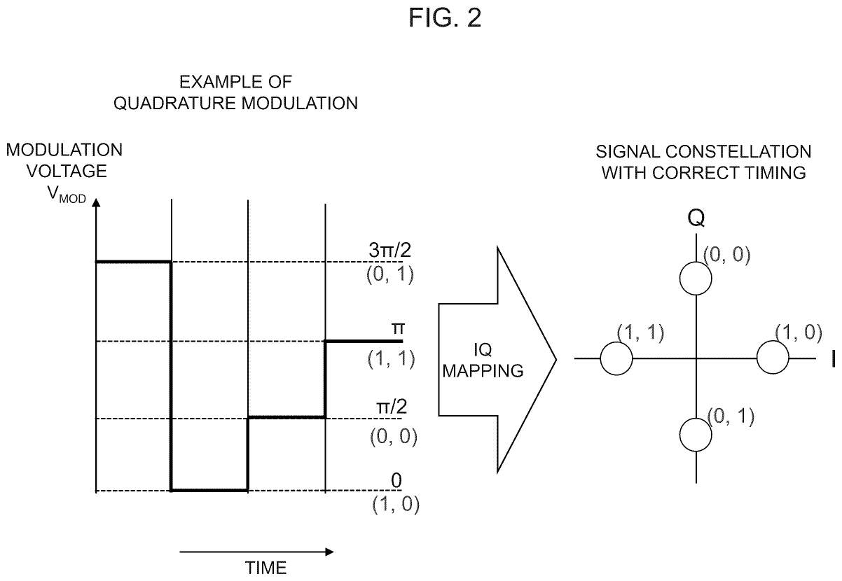

The modulation timing adjustment function realized by the modulation timing adjustment device 10 is described in detail below with reference to FIGS. 2-6. For the sake of simplicity, however, the description will be made taking QPSK modulation as an example.

FIG. 2 illustrates the signal constellation on IQ plane in the case of QPSK modulation. As illustrated in the figure, the modulation voltages V_{MOD} of four values are determined by two bits of data (1, 0), (0, 0), (1, 1), and (0, 1), respectively, each corresponding to phase modulation depths of 0, π/2, π, and 3π/2. The modulator 11 phase-modulates the input light pulse according to the applied modulation voltage V_{MOD}. In this way, each data of the data sequence is mapped to a corresponding signal point of the signal constellation on the IQ plane.

### Optimization Based on Variance

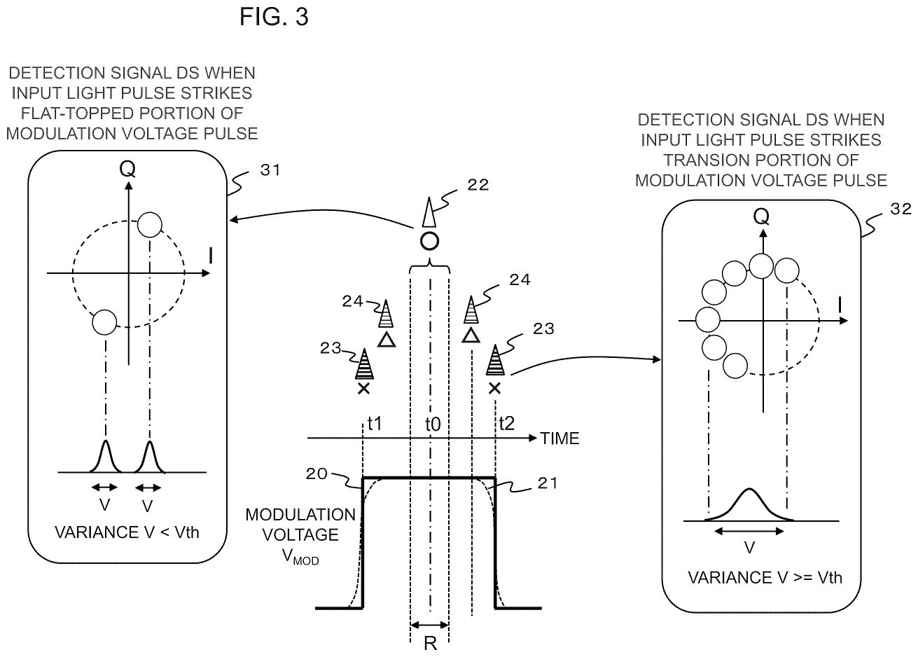

As illustrated schematically in FIG. 3, the modulation voltage V_{MOD} shall rise at time t1, maintain a steady state of the predetermined voltage V_{MOD}, and then fall at time t2. Ideally, the pulse waveform would be rectangular, as shown by waveform 20. In reality, however, the voltage near time points t1 and t2 has a slope before reaching a steady state, and furthermore, it is not stable at the rising time point due to overshooting, etc. (waveform 21). Therefore, it is desirable to adjust the modulation timing so that the input light pulse is modulated at the center R, where the modulation voltage V_{MOD} is stable, to avoid the transition regions which are the rising and falling edges of the modulation voltage V_{MOD}.

Such delicate timing adjustment becomes more exacting as optical communications become faster and the light pulse period and light pulse width become shorter, thus requiring delicate timing control. According to the example embodiment of the present invention, delicate modulation timing adjustment is made possible by monitoring the variance of a detection signal as described below.

Referring to FIG. 3, an input light pulse 22 is assumed to be phase-modulated at the correct modulation timing. In other words, the position of the input light pulse 22 relative to the modulation voltage V_{MOD} is within the center R, allowing the predetermined modulation voltage to be applied in stability to perform the predetermined phase modulation. In the case where the predetermined phase modulation is stably performed in this manner, the detection signal DS of the phase-modulated output light pulse is distributed with a relatively small variance around the correct signal point on the IQ plane (detection signal distribution 31 at stable modulation). For example, if an appropriate threshold value is used, the variance V of the detection signal at that time is smaller than a threshold value.

An input light pulse 23 is assumed to be phase-modulated at the transition near the edge of the modulation voltage V_{MOD}. In this case, the position of the input light pulse 22 relative to the modulation voltage V_{MOD} is at the edge of the modulation voltage V_{MOD}, where the modulation voltage V_{MOD} is changed steeply. Accordingly, it is impossible to determine what level of phase modulation has been performed. In other words, the detection signal DS widely changes in the depth of phase modulation, so that it is distributed with a large variance over multiple signal points on the IQ plane (detection signal distribution 32 at unstable modulation). In the position between the edge of the modulation voltage pulse and the center R, as in an input light pulse 24, the variance V is relatively large when the distortion is large, as in the waveform 21.

By sequentially shifting the modulation timing in this manner, the variance V of the detection signal increases or decreases. Accordingly, the modulation timing that exhibits the minimum variance can be searched for. However, the optimal modulation timing may not be found by such a modulation timing searching method using the minimum variance V as explained hereafter.

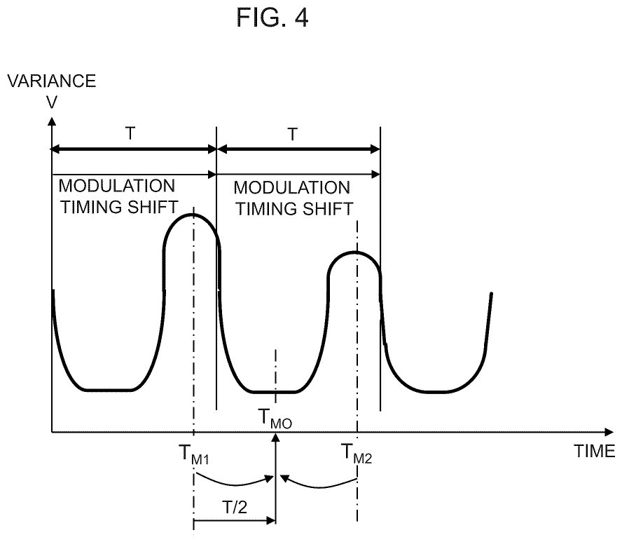

As illustrated in FIG. 4, when the modulation timing is shifted sequentially, the variance V of the detection signal repeatedly increases or decreases in a period of T. Therefore, if there exists the modulation timing where the variance V is at a minimum, as described above, it can be set as a good modulation timing.

However, if the modulation voltage V_{MOD} is close to the ideal waveform 20, there may be multiple modulation timings where the variance V is minimal. In this case, even if one of multiple modulation timings is selected, it may not necessarily be located within the center R of the modulation voltage V_{MOD}. Also, selecting the center timing of the multiple modulation timings does not necessarily mean that it is located in the center R of the modulation voltage V_{MOD}.

In the present example embodiment, the inventor focuses on the fact that when the relative position of the input light pulse 22 is at the edge of the modulation voltage V_{MOD}, i.e., at the transition region, the variance of the detection signal DS is much larger than in other regions of the modulation voltage V_{MOD}. Since the edge of the modulation voltage V_{MOD} always exists as a rising or falling edge, it can be determined that the modulation timing at which the variance is at a maximum within the period T corresponds to the edge of the modulation voltage V_{MOD}.

When the modulation timing at which the variance V is at a maximum is identified, the location of the center R of the modulation voltage V_{MOD} can be identified with respect to that modulation timing as a criterion. As shown in FIG. 4, for example, it can be determined that the midpoint T_{MO} between the adjacent modulation timings T_{M1} and T_{M2} each indicating maximum variance V within a corresponding period of T is the optimal modulation timing within the center R of the modulation voltage. Alternatively, if the modulation timing T_{M1} where the variance V is at a maximum is detected, the timing T_{MO} shifted by half a period (T/2) from the modulation timing T_{M1} can be determined to be the optimal modulation timing within the center R of the modulation voltage.

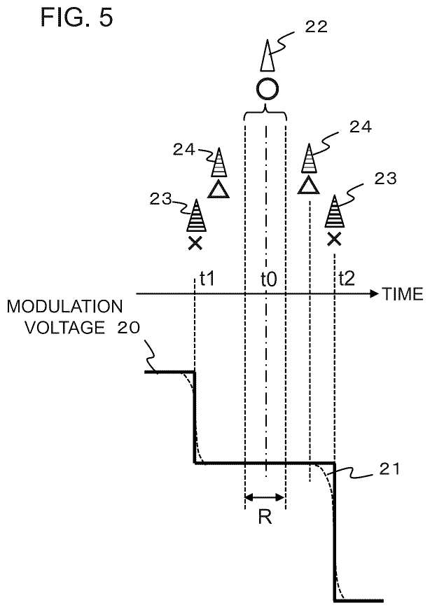

As shown in FIG. 5, when the modulation voltage V_{MOD} varies among multiple voltages, an edge portion is always present as a rising or falling edge. Therefore, even in this case, if the modulation timing that shows the maximum variance is extracted, that timing can be identified as the edge of the modulation voltage V_{MOD}.

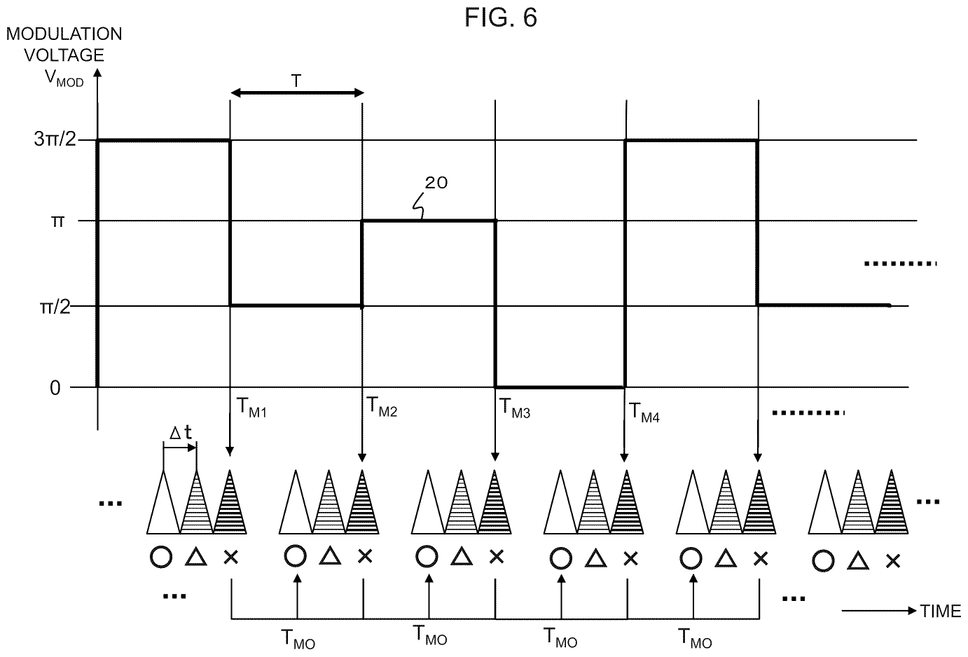

As illustrated in FIG. 6, it is assumed that the modulation voltage V_{MOD} varies at intervals of the period T according to the data sequence. In this case, a first timing setting method for optimal modulation is as follows: the variance V of the detection signal DS is calculated while sequentially shifting the modulation timing by Δt for each input pulse; this method can identify at least two modulation timings T_{M1}, T_{M2}, T_{M3}, . . . at which the variance V shows the maximum value; and then, using adjacent modulation timings T_{M1} and T_{M2} (or T_{M2} and T_{M3}), etc., it can be determined that their midpoint timings T_{MO} are the optimal modulation timings.

Alternatively, a second timing setting method for optimal modulation is as follows: the variance V of the detection signal DS is calculated while sequentially shifting the modulation timing for each input pulse by Δt in the range of one period T; if one modulation timing T_{M1} indicating the maximum variance V is identified, it can be determined that the timing shifted by half a period (T/2) from the modulation timing T_{M1} is the optimal modulation timing within the center R of the modulation voltage.

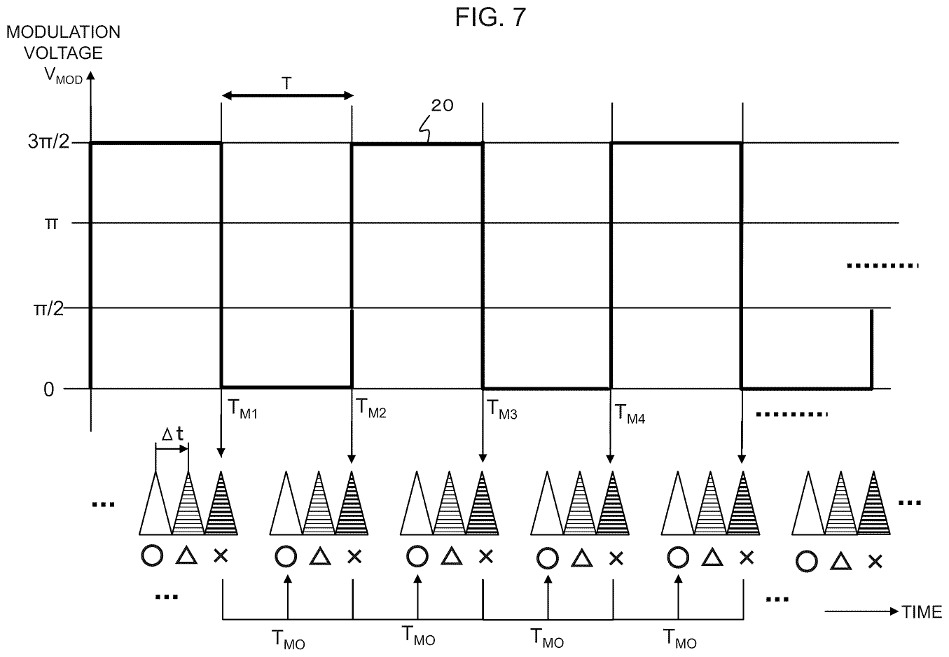

When adjusting the modulation timing, it is desirable that the amplitude of the modulation voltage V_{MOD} changes as large as possible. Therefore, as illustrated in FIG. 7, the modulation voltage V_{MOD} is switched between the highest value V(3π/2) and the lowest value V(0) using a predetermined pattern data sequence. This allows the maximum value of the variance V to be detected more clearly and the optimum modulation timing T_{MO} can be determined with higher reliability.

### 1.3) Control Flow

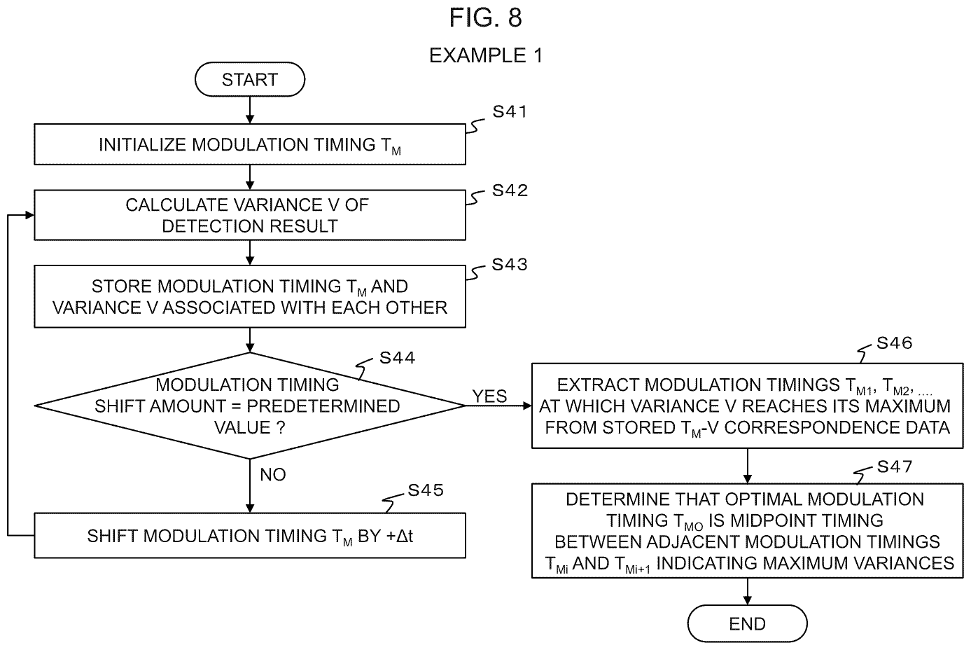

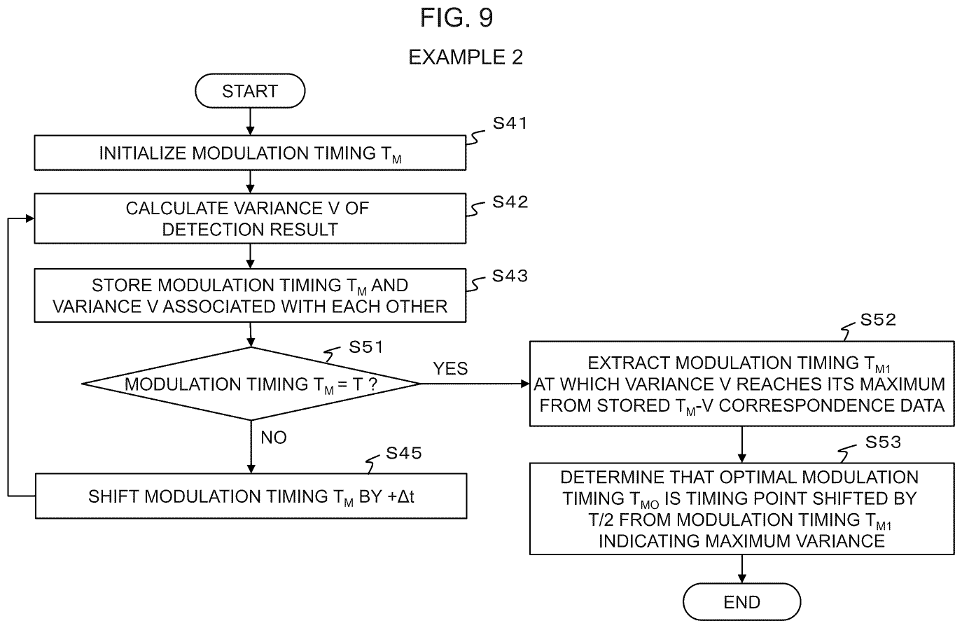

The functions of the modulation timing adjustment device 10 may be realized by a computer. In particular, the functions of the variance calculator 14, controller 15, and modulation timing controller 17 may be realized by executing programs on processors such as a CPU (Central Processing Unit), or by using hardware such as an FPGA (Field-Programmable Gate Array) or ASIC (Application-Specific Integrated Circuit). Hereafter, assuming that a data processor includes a processor, FPGA or ASIC, the first and second examples of modulation timing adjustment realized on the data processor are described with reference to FIGS. 8 and 9.

### Example 1

As shown in FIG. 8, the data processor initializes a modulation timing T_{M} (operation S41). For example, an arbitrary initial modulation timing is set to 0. Then, the data processor calculates the variance V from the detection signal DS detected at a currently set modulation timing T_{M} (operation S42), and stores the modulation timing T_{M} and variance V in the storage unit 16 such that the modulation timing T_{M} and the variance V are associated with each other on the time axis (operation S43).

The data processor then determines whether the set modulation timing T_{M} has reached a predetermined shift amount from the initial value (operation S44). If not (NO in operation S44), the data processor shifts the modulation timing T_{M} by the predetermined step Δt and returns to the above-described operation S42. Thus, operations S42 to S45 are repeated until the modulation timing T_{M} reaches the predetermined shift amount. Here, the predetermined shift amount is two periods (2T) or more.

After shifting the modulation timing T_{M} by 2 periods and calculating the variance V at each modulation timing (YES in operation S44), the data processor extracts the modulation timings T_{M1}, T_{M2}, T_{M3}, . . . , at each of which the variance V reaches its maximum, from the correspondence data between the modulation timing T_{M} and the variance V for two periods stored in the storage section 16 (operation S46). The data processor then determines that the midpoint timing T_{MO} between adjacent modulation timings T_{Mi} and T_{Mi+1} is the optimal modulation timing (operation S47).

### Example 2

As an alternative to the first example described above, the optimal modulation timing can also be determined by shifting the timing by half a period (T/2) from the modulation timing that shows the maximum variance. Hereinafter, the same operations as in the first example are omitted with the same reference signs, and the main operations that differ from the first example will be described.

As shown in FIG. 9, after storing the modulation timing T_{M} and variance V in the storage unit 16 such that the modulation timing T_{M} and the variance V are associated with each other on the time axis (operation S43), the data processor determines whether the set modulation timing T_{M} has reached T for one period from the initial value (operation S51). If it has not reached T (NO in operation S51), the data processor shifts the modulation timing T_{M} by a predetermined step Δt and returns to the above operation S42. Thus, operations S42, S43, S51 and S45 are repeated until the shift amount of modulation timing T_{M} reaches T for one period.

After shifting the modulation timing T_{M} by one period and calculating the variance V at each modulation timing (YES in operation S51), the data processor extracts the modulation timing T_{M1}, at which the variance V reaches a maximum value, from the correspondence data between the modulation timing T_{M} and the variance V for one period stored in the storage unit 16 (operation S52).

When one modulation timing TM1 indicating the maximum variance is identified, the data processor determines that a timing point shifted by half a period (T/2) from the modulation timing T_{M1} is the optimal modulation timing (operation S53).

### 1.3) Effect

As described above, according to the example embodiment, a variance V is calculated from the detection signal DS of an output light pulse train P_{OUT} which has been modulated while shifting the modulation timing T_{M} of the modulator 11. The modulation timing at which the variance V reaches a maximum is used as the criterion for determining the optimal modulation timing.

As an example, two modulation timings each indicating maximum variances are used as criterion timing to determine that the midpoint timing between the two modulation timings is the optimal modulation timing T_{MO}. As another example, one modulation timing indicating a maximum variance is used as criterion timing to determine that the timing shifted by half a period (T/2) from the one modulation timing is the optimal modulation timing T_{MO}.

In this manner, since the optimal modulation timing can be determined based on the variance of a detection signal, there is no need to calculate the error rate or the intensity of combined light as in the background art. As another advantageous effect, the variance of a detection signal can be calculated separately from the stabilization control of the optical system. Accordingly, only the modulation timing can be optimized even if the stabilization control of the optical system is insufficient.

### 2. Example

The modulation timing adjustment device 10 according to the above-described example embodiment may be applied to communication devices that quadrature-modulate an input light pulse train P_{IN} with a predetermined period of T and detect its output light pulse train P_{OUT}. An example in which the above-described example embodiment is applied to an optical communication system will be described below.

In the case where the modulation timing adjustment system 1 as illustrated in FIG. 1 is applied to an optical communication system, the modulator 11 and modulation controller 12 may be installed in a transmitting-side communication device, and the detector 13 and modulation timing adjustment device 10 in a receiving-side communication device. In this case, the input light pulse train P_{IN} is output from a laser light source, and the output light pulse train P_{OUT} of the modulator 11 is transmitted to the receiving-side communication device through an optical transmission path.

The modulator 11 and the modulation controller 12 may be installed in the receiving-side communication device. In this case, the input light pulse train P_{IN} is a light pulse train transmitted by the transmitting communications device through the optical transmission path, and the output light pulse train P_{OUT} is a light pulse train entering the detector 13 through an optical transmission path within the receiving-side communication device.

The functions of the controller 15, storage unit 16, and modulation timing controller 17 of the modulation timing adjustment device 10 may be provided in either the transmitting-side or receiving-side communication device. Hereinafter, a continuous-variable QKD system is taken as an example of the optical communication system.

### 2.1) System Configuration

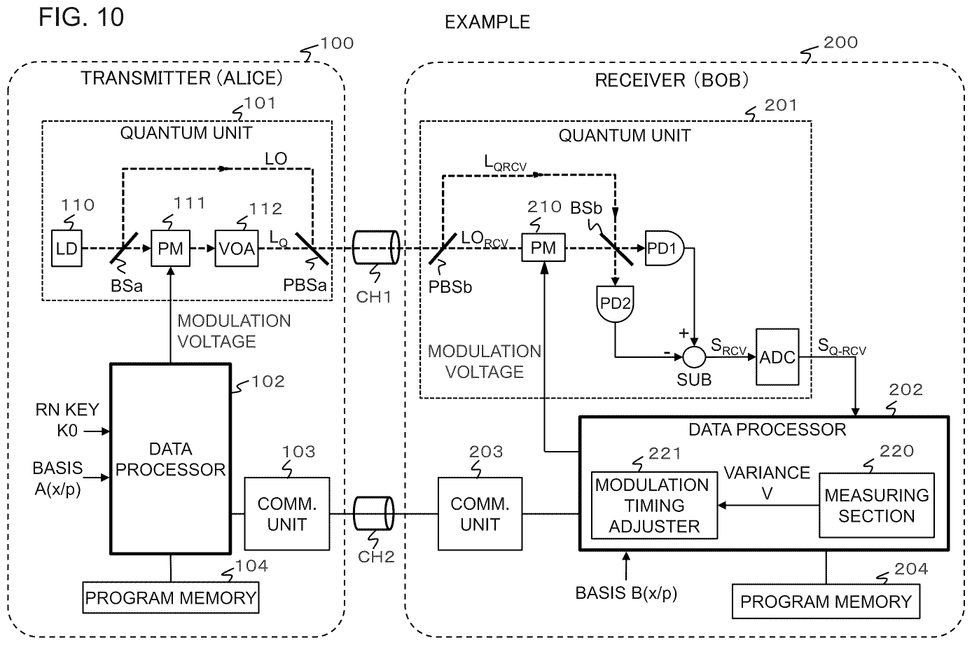

As illustrated in FIG. 10, it is assumed that a continuous-variable QKD system according to an example of the present invention includes a transmitter 100 and a receiver 200, which are connected by a quantum channel CH1 and a classical channel CH2. The quantum channel CH1 is a communication channel transmitting very weak light from the transmitter 100 to the receiver 200. The very weak light has a weak optical power of less than 1 photon/bit. Therefore, the quantum channel is a relatively lossy and noisy and error-prone channel and is less reliable than a normal channel.

The classical channel CH2 is a normal communication channel, through which, for example, an optical signal with optical power of normal intensity is transmitted. Therefore, the classical channel CH2 is a virtually error-free communication channel and has sufficiently high communication reliability. For this reason, the classical channel CH2 is used to exchange information necessary for the transmitter 100 and receiver 200 to perform basis reconciliation, error correction, and privacy amplification in a QKD system. The quantum channel CH1 and the classical channel CH2 may be physically separate transmission channels, or they may be multiplexed into a single optical transmission line.

The transmitter 100 according to the present example includes a quantum unit 101, a data processor 102, a communication unit 103 and a program memory 104. The data processor 102 executes programs stored in the program memory 104 to realize the same function as the modulation controller 12 in FIG. 1. The communication unit 103 performs communication with the receiver 200 using normal light through the classical channel CH2.

The quantum unit 101 includes a laser light source 110, an unpolarizing beam splitter BSa, a phase modulator (PM) 111, a variable attenuator (VOA) 112, and a polarizing beam splitter PBSa. The laser source 110 outputs a train of light pulses having the period T. The beam splitter BSa splits each light pulse emitted from the laser source 110 into two light pulses at a predetermined ratio: one of the two light pulses passes through a reference light path; and the other through a signal light path. The split ratio is a value at which reference light becomes sufficiently stronger than signal light, e.g., reference light: signal light=99:1.

Reference light pulses LO on the reference light path enter the polarizing beam splitter PBSa as they are (alternatively, through a phase modulator not shown). The reference light pulses LO are reflected off the polarizing beam splitter PBSa to become reference light pulses of specified linear polarization, which are transmitted to the receiver 200 through the quantum channel CH1. Signal light pulses on the signal light path enter the polarizing beam splitter PBSa as very weak signal light pulses L_{Q} through the phase modulator 111 and variable attenuator 112. The very weak signal light pulses L_{Q} are transmitted through the polarizing beam splitter PBSa, by which they become linear-polarized signal light pulses orthogonal to the linear polarization of the reference light pulses. The linear-polarized signal light pulses are transmitted to the receiver 200 through the quantum channel CH1.

In the present example, the phase modulator 111 is a QPSK modulator, which performs any one of phase modulations 0, π/2, π and 3π/2 on each signal light pulse according to a random sequence consisting of source key K0 and a basis A. The signal light pulses thus phase-modulated becomes very weak light pulses L_{Q} of less than one photon/bit by the variable attenuator 112 and is transmitted to the receiver 200 through the polarizing beam splitter PBSa and the quantum channel CH1.

The receiver 200 according to the present example includes a quantum unit 201, a data processor 202, a communication unit 203, and a program memory 204. The data processor 202 executes programs stored in the program memory 204 to realize the modulation timing adjustment function as described above. The communication unit 203 performs communication by normal light with the communication unit 103 of the transmitter 100 through the classical channel CH2.

The quantum unit 201 includes a polarizing beam splitter PBSb, a phase modulator (PM) 210, an unpolarizing beam splitter BSb, photo detectors PD1 and PD2, a subtractor SUB, and an analog-to-digital converter ADC. Each light pulse of the light pulse train received from the transmitter 100 through the quantum channel CH1 is split by the polarizing beam splitter PBSb into a received signal light pulse L_{QRCV} and a received reference light pulse LO_{RCV}.

The receive signal light pulses L_{QRCV} enter one input port of the beam splitter BSb as they are (alternatively through a phase modulator not shown). The received reference light pulses LO_{RCV} are phase-modulated by the phase modulator 210 and enters the other input port of beam splitter BSb. The phase modulator 210 is driven by the data processor 201 according to a basis B(x, p) which is a random number. In the present example, the basis B(x, p) corresponds to the depths of phase modulation (0, π/2), respectively. The received signal light pulses L_{QRCV} and the phase-modulated received reference light pulses LO_{RCV} enter the beam splitter BSb.

The beam splitter BSb has equal light transmittance and reflectance, superimposes each received signal light pulse L_{QRCV} and a corresponding received reference light pulse LO_{RCV}, and outputs two output beams to the photo detectors PD1 and PD2, respectively. Therefore, the beam splitter BSa of the transmitter 100 and the beam splitter BSb of the receiver 200 forms a single interferometer.

The subtractor SUB calculates a difference between signals detected respectively by photodetectors PD1 and PD2. A difference signal S_{RCV}, which is the output of the subtractor SUB, is quantized by the ADC. The quantized difference signal is output as a detection signal S_{Q-RCV} to the data processor 202.

The above-described reception method such that the interferometer is formed for the received signal light pulse L_{QRCV} and the received reference light pulse LO_{RCV} to interfere with each other, is called self-homodyne detection. The self-homodyne detection advantageously eliminates the need to compensate for the wavelength difference between the signal light and local light. In addition, since a reference light with high optical power is used, the optical amplification effect of the signal light can be obtained. Therefore, even if the power of the signal light is weak, less than one photon/bit, it can be detected using a commonly-used photodetector PD.

### 2.2) Modulation Timing Adjustment

The data processor 202 includes the functions of measuring section 220 and modulation timing adjuster 221. The measuring section 220 calculates the variance V from the detection signal S_{Q-RCV} and outputs it to the modulation timing adjuster 221. The variance calculation function of the measuring section 220 may also use the pre-equipped function of a receiver-side detector in the continuous-variable QKD system.

The modulation timing adjuster 221 may calculate the variance V at each modulation timing while shifting the modulation timing T_{M} for each of the phase modulator 111 of the transmitter 100 or the phase modulator 210 of the receiver 200, and determine that the middle point between two modulation timings at each of which the variance V reaches a maximum is the optimal modulation timing T_{MO}. Accordingly, the modulation timing adjuster 221 includes the functions of the controller 15, storage section 16, and modulation timing controller 17 as shown in FIG. 1.

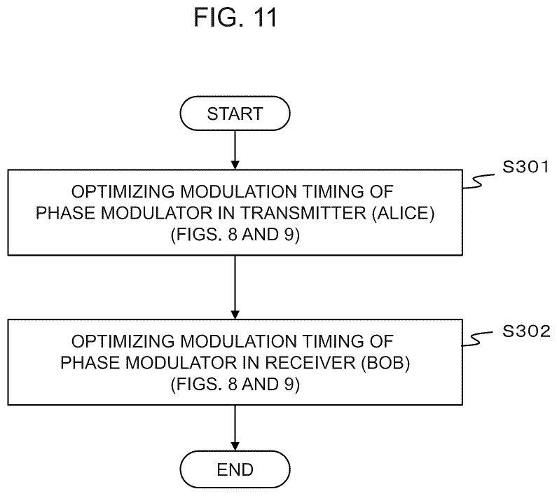

As illustrated in FIG. 11, the modulation timing adjuster 221 of the data processor 202 adjusts the modulation timing of the phase modulator 111 of the transmitter 100 through the communication units 203 and 103 (operation S301). This modulation timing adjustment flow is shown in FIG. 8 or FIG. 9. However, when adjusting the modulation timing of the phase modulator 111 on the transmitter side, the modulation of the phase modulator 210 on the receiver side is halted.

When the modulation timing adjustment on the transmitter side is completed, the modulation timing adjuster 221 of the data processor 202 adjusts the modulation timing of the phase modulator 210 of the receiver 200 (operation S302). This modulation timing adjustment flow is also shown in FIG. 8 or FIG. 9. In this way, the phase modulation timing of the transmitter 100 and the phase modulation timing of the receiver 201 can be adjusted respectively to the optimal modulation timing.

As described above, while shifting the modulation timing T_{M} of each of the phase modulator 111 of the transmitter 100 or the phase modulator 210 of the receiver 200, the variance V at each modulation timing is calculated. The modulation timing indicating the maximum variance V is used as the criterion for determining the optimal modulation timing. More specifically, the first example (FIG. 8) or the second example (FIG. 9) described above can be applied to the modulation timing adjustment. Such a modulation timing adjustment method allows the modulation timing to be optimized by monitoring the variance even when the phase difference of the interferometer between the quantum unit 101 and the quantum unit 201 is not stable.

After the modulation timing is thus optimized and the phase difference of the interferometer between the quantum unit 101 and quantum unit 201 is stabilized, a key generation process such as very weak light transmission and basis reconciliation in the QKD system are performed as described below.

### 2.3) Key Generation Process

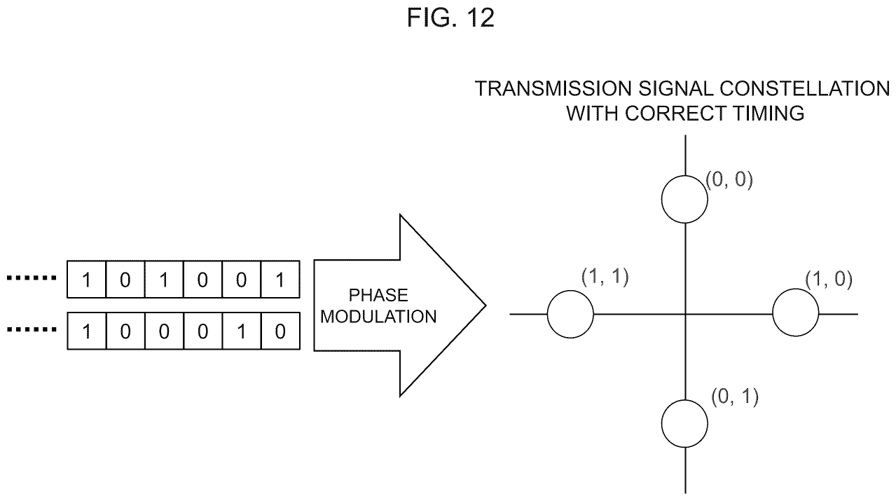

As illustrated in FIG. 12, the quantum unit 101 of transmitter 100 transmits a very weak light L_{Q} phase-modulated according to source key K0 and basis A. The source key K0 is a sequence of random numbers that will be the source data from which a final key is generated. The basis A is also a sequence of random numbers 0/1. For the convenience in writing, the 0/1 of basis A are denoted by x/p. Such a 2-bit random number consisting of the source key K0 and basis A is mapped to any one of the four signal constellation points on the IQ plane. For example, if the basis A=“x”, the source key K0=“1” is mapped to signal constellation point (x, 1), and K0=“0” is mapped to signal constellation point (x, 0). In other words, the I signal and Q signal with a phase difference of 90° correspond to the value of basis A (x/p), and the signal value 0/1 corresponds to the source key K0.

The very weak light L_{Q} is subjected to four different phase modulations: 0°, 90°, 180°, and 270° according to a random number sequence of the source key K0 and basis A. The very weak light L_{Q} thus phase-modulated is transmitted from the quantum unit 101 to the quantum unit 201 through the quantum channel CH1.

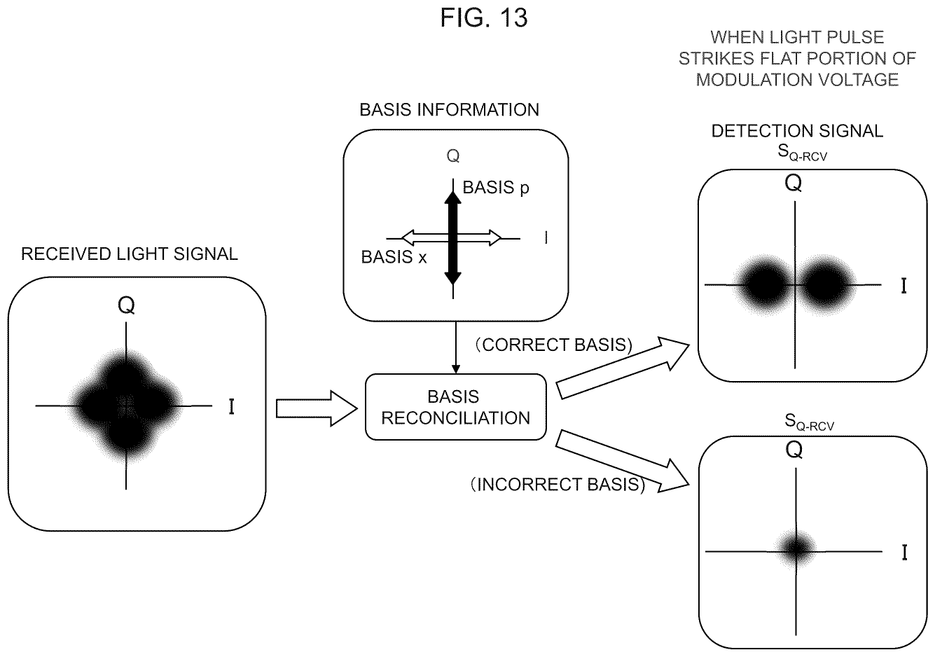

If quantum fluctuations did not exist, there would be no variation in the measured values at the receiver 200, as shown by the transmitted signal constellation of FIG. 12. However, quantum fluctuations cause variations in the amplitude measurements of the received signal. The reception state caused by quantum fluctuations is illustrated as received light in FIG. 13.

In FIG. 13, if the basis A (x or p) is known when the transmitter 100 generates very weak light, then the receiver 200 can generate the detection signal S_{Q-RCV} by performing basis reconciliation using that basis information. In the present example, the basis A used by the transmitter 100 and the basis B used by the receiver 200 are compared through the classical channel CH2. The detection signal S_{Q-RCV} is generated based on only the matched basis.

For example, if the matched basis A=B=x, then the I axis can be selected to obtain the detection signal S_{Q-RCV} in either of the two regions (correct basis). Thus, if basis reconciliation is correct, soft decision can be used to determine which is a received symbol. In contrast, if the bases do not match (basis A=x, basis B=p), only detection signals distributed near the origin of the IQ plane may be obtained. Accordingly, it is impossible to determine which is a received symbol (incorrect basis).

After the basis reconciliation described above, error correction and privacy amplification are performed to share a final encryption key between the transmitter 100 and receiver 200.

### 3. Additional Statements

Part or all of the above-described illustrative example embodiments can also be described as, but are not limited to, the following additional statements.

### (Additional Statement 1)

A modulation timing adjustment device that adjusts modulation timing of a modulator that modulates a train of light pulses with a predetermined period, the device comprising:
a variance calculator that calculates a variance of a detection signal of an output light pulse of the modulator; and
a controller that, while shifting the modulation timing of the modulator, obtains the variance of the detection signal at each modulation timing, and adjusts the modulation timing based on the variance,
wherein the controller determines modulation timing at which the variance reaches a maximum as a criterion for determining an optimal modulation timing.

### (Additional Statement 2)

The modulation timing adjustment device according to additional statement 1, wherein the modulator performs modulation depending on which one of a plurality of voltages is applied as a modulation voltage, wherein the controller changes the modulation voltage at intervals of the predetermined period.

### (Additional Statement 3)

The modulation timing adjustment device according to additional statement 2, wherein the modulation voltage has a transition region which is its rising or falling edge.

### (Additional Statement 4)

The modulation timing adjustment device according to additional statement 2, wherein the controller, when adjusting the modulation timing, changes the modulation voltage between a highest voltage and a lowest voltage of the plurality of voltages.

### (Additional Statement 5)

The modulation timing adjustment device according to any one of additional statements 1-4, wherein the controller sequentially shifts the modulation timing of the modulator by a predetermined step over the predetermined period, and determines, as the optimal modulation timing, a time instant shifted half the predetermined period from the modulation timing at which the variance reaches its maximum within the predetermined period.

### (Additional Statement 6)

The modulation timing adjustment device according to any one of additional statement 1-4, wherein the controller sequentially shifts the modulation timing of the modulator by a predetermined step over the predetermined period, and determines, as the optimal modulation timing, a midpoint time instant between two adjacent modulation timings of modulation timings at which the variance reaches its maximum within the predetermined period.

### (Additional Statement 7)

A modulation timing adjustment method for a data processor to adjust modulation timing of a modulator that modulates a light pulse train with a predetermined period, the method comprising:
calculating a variance of a detection signal obtained by detecting an output light pulse train of the modulator while shifting the modulation timing of the modulator; and
optimizing the modulation timing using the modulation timing at which the variance reaches a maximum as a criterion timing.

### (Additional Statement 8)

The modulation timing adjustment method according to additional statement 7, wherein the modulator performs modulation depending on which one of a plurality of voltages is applied as a modulation voltage, wherein the modulation voltage is changed at intervals of the predetermined period.

### (Additional Statement 9)

The modulation timing adjustment method according to additional statement 8, wherein the modulation voltage has a transition region which is its rising or falling edge.

### (Additional Statement 10)

The modulation timing adjustment method according to additional statement 8, wherein, when adjusting the modulation timing, the modulation voltage is changed between a highest voltage and a lowest voltage of the plurality of voltages.

### (Additional Statement 11)

The modulation timing adjustment method according to any one of additional statements 7-10, wherein the modulation timing of the modulator is sequentially shifted by a predetermined step over the predetermined period, and it is determined that the optimal modulation timing is a time instant shifted half the predetermined period from a modulation timing at which the variance reaches its maximum within the predetermined period, as criterion timing.

### (Additional Statement 12)

The modulation timing adjustment method according to any one of additional statement 7-10, wherein the modulation timing of the modulator is sequentially shifted by a predetermined step over the predetermined period, and it is determined that the optimal modulation timing is a midpoint between two adjacent modulation timings of modulation timings at which the variance reaches its maximum within the predetermined period, as criterion timings.

### (Additional Statement 13)

A program that functions a computer as a modulation timing adjustment device for adjusting modulation timing of a modulator that modulates a light pulse train with a predetermined period, the program implementing, on the computer, functions of:
calculating a variance of a detection signal obtained by detecting an output light pulse train of the modulator while shifting the modulation timing of the modulator; and
optimizing the modulation timing using the modulation timing at which the variance reaches a maximum as a criterion timing.

### (Additional Statement 14)

The program according to additional statement 13, wherein the modulator performs modulation depending on which one of a plurality of voltages is applied as a modulation voltage, wherein the modulation voltage is changed at intervals of the predetermined period.

### (Additional Statement 15)

The program according to additional statement 14, wherein the modulation voltage has a transition region which is its rising or falling edge.

### (Additional Statement 16)

The program according to additional statement 14, wherein, when adjusting the modulation timing, the modulation voltage is changed between a highest voltage and a lowest voltage of the plurality of voltages.

### (Additional Statement 17)

The program according to any one of additional statements 13-16, wherein the modulation timing of the modulator is sequentially shifted by a predetermined step over the predetermined period, and it is determined that the optimal modulation timing is a time instant shifted half the predetermined period from the modulation timing at which the variance reaches its maximum within the predetermined period as the criterion timing.

### (Additional Statement 18)

The program according to any one of additional statement 13-16, wherein the modulation timing of the modulator is sequentially shifted by a predetermined step over the predetermined period, and it is determined that the optimal modulation timing is a midpoint between two adjacent modulation timings of modulation timings at which the variance reaches its maximum within the predetermined period as the criterion timing.

### (Additional Statement 19]

A receiver connected to a transmitter through an optical transmission path in an optical communication system, the receiver comprising:
a reception unit that receives an output light pulse train of a modulator of the transmitter to detect a detection signal from the output light pulse train, wherein the modulator modulates a light pulse train with a predetermined period to output the output light pulse train;
a variance calculator that calculates a variance of the detection signal; and
a controller that, while shifting the modulation timing of the modulator, obtains the variance of the detection signal at each modulation timing, and optimizes the modulation timing using the modulation timing at which the variance reaches a maximum as a criterion timing.

### (Additional Statement 20)

The receiver according to additional statement 19, wherein the modulator performs modulation depending on which one of a plurality of voltages is applied as a modulation voltage, wherein the controller changes the modulation voltage at intervals of the predetermined period.

### (Additional Statement 21)

The receiver according to additional statement 20, wherein the modulation voltage has a transition region which is its rising or falling edge.

### (Additional Statement 22)

The receiver according to additional statement 20, wherein the controller, when adjusting the modulation timing, changes the modulation voltage between a highest voltage and a lowest voltage of the plurality of voltages.

### (Additional Statement 23)

The receiver according to any one of additional statements 19-22, wherein the controller sequentially shifts the modulation timing of the modulator by a predetermined step over the predetermined period, and determines, as the optimal modulation timing, a time instant shifted half the predetermined period from the modulation timing at which the variance reaches its maximum within the predetermined period, as the criterion timing.

### (Additional Statement 24)

The receiver according to any one of additional statement 19-22, wherein the controller sequentially shifts the modulation timing of the modulator by a predetermined step over the predetermined period, and determines, as the optimal modulation timing, a midpoint time instant between two adjacent modulation timings of modulation timings at which the variance reaches its maximum within the predetermined period, as the criterion timing.

### (Additional Statement 25)

A receiver connected to a transmitter through an optical transmission path in an optical communication system, the receiver comprising:
a reception unit that receives a first output light pulse train of a first modulator of the transmitter, wherein the first modulator modulates a light pulse train with a predetermined period to output the first output light pulse train;
a second modulator that modulates the first output light pulse train received from the transmitter through the optical transmission path;
a variance calculator that calculates a variance of a detection signal obtained by detecting the second output light pulse train of the second modulator; and
a controller that adjusts modulation timing of the first modulator and the second modulator based on the variance,
wherein the controller, while shifting the modulation timing of the first modulator in a state of halting modulation operation of the second modulator, obtains the variance of the detection signal at each modulation timing, and optimizes the modulation timing of the first modulator using the modulation timing at which the variance reaches a maximum as a criterion timing; and

### (Additional Statement 26)

The receiver according to additional statement 25, wherein the controller, after having optimized the modulation timing of the first modulator, while shifting the modulation timing of the second modulator, obtains the variance of the detection signal at each modulation timing, and optimizes the modulation timing of the second modulator using the modulation timing at which the variance reaches a maximum as the criterion timing.

### Industrial Applicability

The present invention is applicable to optical communication systems including modulators that modulate light pulses with a predetermined period.

### REFERENCE SIGNS LIST

10 Modulation timing adjustment device
11 Modulator
12 Modulation controller
13 Detector
14 Variance calculator
15 Controller
16 Storage unit
17 Modulation timing controller

What is claimed is:

1. A device that adjusts modulation timing of a modulator that modulates a light pulse train with a predetermined period, the device comprising:
a variance calculator that calculates a variance of a detection signal of an output light pulse of the modulator; and
a controller configured to:
while shifting the modulation timing of the modulator, obtain the variance of the detection signal at each modulation timing;
determine modulation timing at which the variance reaches a maximum as a criterion for determining an optimal modulation timing; and
adjust the modulation timing with reference to the modulation timing as the criterion.

2. The device according to claim 1, wherein the modulator performs modulation depending on which one of a plurality of voltages is applied as a modulation voltage, wherein the controller is further configured to change the modulation voltage at intervals of the predetermined period.

3. The device according to claim 2, wherein the modulation voltage has a transition region which is its rising or falling edge.

4. The device according to claim 2, wherein the controller is further configured to, when adjusting the modulation timing, change the modulation voltage between a highest voltage and a lowest voltage of the plurality of voltages.

5. The device according to claim 1, wherein the controller is further configured to:
sequentially shift the modulation timing of the modulator by a predetermined step over the predetermined period; and
determine, as the optimal modulation timing, a time instant shifted half the predetermined period from the modulation timing at which the variance reaches its maximum within the predetermined period.

6. The device according to claim 1, wherein the controller is further configured to:
sequentially shifts the modulation timing of the modulator by a predetermined step over the predetermined period; and
determine, as the optimal modulation timing, a midpoint time instant between two adjacent modulation timings of modulation timings at which the variance reaches its maximum within the predetermined period.

7. A method for a data processor to adjust modulation timing of a modulator that modulates a train of light pulses a predetermined period, the method comprising:
calculating a variance of a detection signal obtained by detecting an output light pulse train of the modulator while shifting the modulation timing of the modulator; and
optimizing the modulation timing using a modulation timing at which the variance reaches a maximum as a criterion timing.

8-10. (canceled)

11. The method according to claim 7, wherein the modulator performs modulation depending on which one of a plurality of voltages is applied as a modulation voltage, wherein the modulation voltage is changed at intervals of the predetermined period.

12. The method according to claim 11, wherein, when adjusting the modulation timing, the modulation voltage is changed between a highest voltage and a lowest voltage of the plurality of voltages.

13. The method according to claim 7, wherein the modulation timing of the modulator is sequentially shifted by a predetermined step over the predetermined period, and it is determined that the optimal modulation timing is a time instant shifted half the predetermined period from a modulation timing at which the variance reaches its maximum within the predetermined period, as criterion timing.

14. The method according to claim 7, wherein the modulation timing of the modulator is sequentially shifted by a predetermined step over the predetermined period, and it is determined that the optimal modulation timing is a midpoint between two adjacent modulation timings of modulation timings at which the variance reaches its maximum within the predetermined period, as criterion timings.

15. A receiver connected to a transmitter through an optical transmission path in an optical communication system, wherein the transmitter includes a modulator that modulates a train of light pulses with a predetermined period to generate an output light pulse train, which is transmitted to the receiver through the optical transmission path, the receiver comprising:
a reception unit that receives the output light pulse train from the transmitter to detect a detection signal; and
a controller configured to:
calculate a variance of the detection signal;
while shifting the modulation timing of the modulator, input the variance of the detection signal at each modulation timing; and
optimize the modulation timing using a modulation timing at which the variance reaches a maximum as a criterion timing.

16. The receiver according to claim 15, wherein the modulator performs modulation depending on which one of a plurality of voltages is applied as a modulation voltage, wherein the controller is further configured to change the modulation voltage at intervals of the predetermined period.

17. The receiver according to claim 16, wherein the controller, when adjusting the modulation timing, changes the modulation voltage between a highest voltage and a lowest voltage of the plurality of voltages.

18. The receiver according to claim 15, wherein the controller sequentially shifts the modulation timing of the modulator by a predetermined step over the predetermined period, and determines, as the optimal modulation timing, a time instant shifted half the predetermined period from the modulation timing at which the variance reaches its maximum within the predetermined period, as the criterion timing.

19. The receiver according to claim 15, wherein the controller sequentially shifts the modulation timing of the modulator by a predetermined step over the predetermined period, and determines, as the optimal modulation timing, a midpoint time instant between two adjacent modulation timings of modulation timings at which the variance reaches its maximum within the predetermined period, as the criterion timing.
